(19) United States
(12) Patent Application Publication
(10) Pub. No.: US 2024/0263880 A1
(43) Pub. Date: Aug. 8, 2024

(54) HIGH FREQUENCY SKULL CRUCIBLE FOR MELTING HIGH REFRACTIVE INDEX METAL OXIDE AND HIGH REFRACTIVE INDEX METAL OXIDE MELTING SYSTEM HAVING SAME

(71) Applicants: Jae Koo OH, Seoul (KR); Peter C.` BRANSFIELD, Northbridge, MA (US)

(72) Inventors: Jae Koo OH, Seoul (KR); Jae Kun LEE, Asan-si (KR)

(21) Appl. No.: 18/431,049

(22) Filed: Feb. 2, 2024

(30) Foreign Application Priority Data
Feb. 7, 2023 (KR) 10-2023-0016441

(51) Int. Cl. F27B 14/06; F27B 14/10

(52) U.S. Cl. CPC F27B 14/063; F27B 14/10; F27B 2014/102

(57) ABSTRACT

Provided is a high frequency skull crucible including: a side wall close to a raw material feeder and a side wall on which an outlet is formed, the two side walls being located vertically to face each other; a body located between the two side walls; and high frequency coils adapted to surround a portion of the body that is close to the side wall on which the outlet is formed, wherein the side wall on which the outlet is formed has the outlet formed on top thereof to discharge a melt, the body has the shape of a horizontally located semicylinder or the shape of a horizontally located cylinder whose given upper portion is cut, and the body is inclinedly located on the ground to allow the melt to be made consistently.

### CROSS REFERENCE TO RELATED APPLICATION OF THE DISCLOSURE

The present application claims the benefit of Korean Patent Application No. 10-2023-0016441 filed in the Korean Intellectual Property Office Feb. 7, 2023, the entire contents of which are incorporated herein by reference.

### BACKGROUND OF THE DISCLOSURE

### Field of the Disclosure

The present disclosure relates to a high frequency skull crucible using high frequency induction heating that is used in manufacturing a metal oxide melt having a high refractive index and a high specific gravity and a high frequency melting system having the same, and more specifically to a high frequency skull crucible that is provided with fingers arranged horizontally to make a metal oxide melt consistently and a high frequency melting system having the same.

The present disclosure relates to a high frequency skull crucible for melting a metal oxide having an ultra-high temperature melting point, such as titanium dioxide, zinc oxide, zirconia, and the like, desirably to a high frequency skull crucible for melting zirconia.

The present disclosure relates to a high frequency melting system for making a metal oxide melt, while simultaneously making metal oxide beads consistently.

### Background of the Related Art

As market demands for autonomous vehicles have increased, recently, many studies and developments of the autonomous vehicles have been made.

To allow a vehicle to be autonomously driven, an autonomous driving system has to be improved in performance, and further, there is a need to improve reflection performance of road signs so that the autonomous driving system can recognize road lanes obviously.

To allow road signs and lanes to be vividly recognized by cameras of the autonomous driving system, the road signs having excellent retroreflective performance are required, and to do this, high refractive index metal oxide beads having excellent retroreflective performance are utilized for road signs.

However, metal oxides having high refractive indexes of 2.0 or more, which have excellent retroreflective performance, have substantially high melting points, as shown in Table 1, so that they are hard to be melted using a general heating furnace, and besides, it is very difficult to mold metal oxide beads from a high-temperature metal oxide melt.

TABLE 1

| Metal | Refractive | Melting | Specific |
|---|---|---|---|
| oxide | index | temperature (° C.) | gravity |
| TiO₂ | 2.49 | 1,843 | 3.78 |
| ZrO₂ | 2.13 | 2,715 | 5.68 |
| ZnO | 2.01 | 1,974 | 5.61 |

A high frequency induction heating device and a method for making a melt using the same is disclosed in Korean Patent Application Laid-open No. 10-2006-0104780 (Dated on Oct. 9, 2006). However, the conventional high frequency induction heating device is provided with a typically used crucible that is located vertically, which is not adequate for making metal oxide beads.

A skull device for making a glass product from a glass melt is disclosed in Korean Patent No. 10-1781212 (Issued on Sep. 22, 2017), but even the conventional skull device is provided with a crucible that is located vertically, which is not adequate for making a melt from a metal oxide whose load is high.

Therefore, there is a need to develop a new skull crucible that is capable of being stable structurally in melting a metal oxide having a high refractive index and a high specific gravity and making a metal oxide melt consistently.

Further, there is a need to develop a new system that is capable of easily making metal oxide beads from a metal oxide melt.

### PRIOR ART DOCUMENT

### Patent Document

(Patent document 0001) Korean Patent Application Laid-open No. 10-2006-0104780 (Dated on Oct. 9, 2006)
(Patent document 0002) Korean Patent No. 10-1781212 (Issued on Sep. 22, 2017)

### SUMMARY OF THE DISCLOSURE

Accordingly, the present disclosure has been made in view of the above-mentioned problems occurring in the related art, and it is an object of the present disclosure to provide a skull crucible that is capable of being stable structurally so that a metal oxide having a high refractive index and a high specific gravity is melted stably, while consistently making a metal oxide melt.

It is another object of the present disclosure to provide a system that is capable of easily making metal oxide beads from a metal oxide melt.

To accomplish the above-mentioned objects, according to one aspect of the present disclosure, there is provided a high frequency skull crucible including: two side walls located vertically to face each other; a body located between the two side walls; and high frequency coils adapted to surround one side portion of the body, wherein the two side walls and the body may have the shape of a semicylinder or the shape of a cylinder whose given upper portion is cut.

As a result, the high frequency skull crucible according to the present disclosure may be located inclinedly by a given angle on the ground in such a way as to allow a melt to be made consistently.

According to the present disclosure, desirably, the body may include a plurality of fingers having the shape of a pipe with grooves formed thereon to insert insulation rods thereinto, so that gaps are formed among the neighboring fingers in such a way as to pass magnetic force lines generated from the high frequency coils therethrough. According to the present disclosure, desirably, the insulation rods may be made from Teflon. As a result, the high frequency skull crucible according to the present disclosure may be more resistant to high load than that where the cylindrical pipes are simply arranged side by side, while having gaps thereamong.

According to the present disclosure, desirably, the body may further include a reinforced layer formed on the outsides of the fingers, and the reinforced layer may be made from an epoxy resin.

As a result, the reinforced layer may be formed on the outsides of the fingers, thereby making it possible to make the high frequency skull crucible having a strong structure.

According to the present disclosure, desirably, the two side walls may include the side wall close to a raw material feeder and the side wall on which an outlet is formed, the side wall close to the raw material feeder may be in fluid communication with the plurality of fingers, and cooling water may be fed to the side wall close to the raw material feeder and the plurality of fingers to cool the melt, so that while a metal oxide is being melted, crust may be formed to prevent the melt from leaking.

According to the present disclosure, desirably, some of the plurality of fingers may be fixed to the outer surface of the side wall on which the outlet is formed, whereas some of the plurality of fingers may be located in such a way as to allow the ends thereof to be brought into contact with the inner surface of the side wall on which the outlet is formed, and the plurality of fingers fixed to the outer surface of the side wall on which the outlet is formed may be alternately arranged with the plurality of fingers located in such a way as to allow the ends thereof to be brought into contact with the inner surface of the side wall on which the outlet is formed.

As a result, the side wall on which the outlet is formed may be prevented from moving forward and backward by means of the plurality of fingers, so that the side wall may be stably fixed, without any additional fixing device, and the fingers may be kept open, not closed.

According to the present disclosure, desirably, the side wall close to the raw material feeder may be made from stainless steel, the plurality of fingers may be made from copper, and the side wall on which the outlet is formed may be made from a high refractive index metal oxide brick or fused cast refractory.

According to the present disclosure, desirably, the high frequency skull crucible may further include a cooling structure located on the outer surface of the side wall on which the outlet is formed to cool the side wall on which the outlet is formed, and the cooling structure may include a metal plate fixed to the side wall on which the outlet is formed and a cooling pipe welded to the metal plate.

According to the present disclosure, desirably, the high frequency skull crucible may further include a pair of electrode rods passing through the side wall close to the raw material feeder and the side wall on which the outlet is formed in such a way as to be located to face each other, each electrode rod including an electrode and a cooling pipe for surrounding the electrode in such a way as to allow cooling water to flow therein and therefrom, and the electrode may be made from molybdenum.

As a result, the high frequency skull crucible according to the present disclosure may stably maintain the melting temperature of the high refractive index metal oxide whose resistivity and permeability values are varied at a temperature higher than the melting point thereof.

According to the present disclosure, desirably, the outlet may be formed on the side wall to discharge the melt therefrom, and the outlet may have a pair of electrode rods formed thereon to heat the melt discharged therefrom. According to the present disclosure, desirably, each electrode rod may include an electrode and a cooling pipe connected to the electrode.

As a result, the high frequency skull crucible according to the present disclosure may prevent, while the high temperature melt is being discharged through the outlet, the melt from being cool in the outlet and thus clogging the outlet, thereby making the metal oxide melt consistently.

According to the present disclosure, desirably, the electrode may be made from a rhodium-platinum alloy to prevent the abrasion caused by contact and friction with the melt having high viscosity from occurring.

To accomplish the above-mentioned objects, according to another aspect of the present disclosure, there is provided a high refractive index metal oxide melting system including: a high frequency skull crucible; a raw material feeder located above the high frequency skull crucible to feed a raw material to the interior of the high frequency skull crucible; and an ascending and descending part for moving up and down a side wall close to the raw material feeder of the high frequency skull crucible, wherein the high frequency skull crucible has a side wall on which an outlet is formed.

As a result, the high refractive index metal oxide melting system according to the present disclosure may allow the high frequency skull crucible to be inclinedly located on the ground, if necessary, thereby making the melt consistently.

According to the present disclosure, desirably, the high refractive index metal oxide melting system may further include an air nozzle located on one surface or one side of the side wall on which the outlet is formed to inject air into the melt discharged through the outlet.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a plan view showing a high refractive index metal oxide melting system according to the present disclosure;

FIG. 2 is side views showing the high refractive index metal oxide melting system according to the present disclosure;

FIG. 3 shows a connection structure in which fingers are connected to a side wall close to a raw material feeder and to a side wall on which an outlet is formed in the system according to the present disclosure;

FIG. 4 shows a cooling structure of the side wall on which the outlet is formed;

FIG. 5 shows a reinforced structure among fingers constituting a body of a high frequency skull crucible of the system according to the present disclosure;

FIG. 6 shows states where high frequency coils are fixedly connected to the fingers;

FIG. 7 shows first and second electrode rods;

FIG. 8 shows the outlet having third and fourth electrode rods; and

FIG. 9 shows an example where metal oxide beads are made using the high refractive index metal oxide melting system according to the present disclosure.

### DETAILED DESCRIPTION

Terms used in this application are used to only describe specific exemplary embodiments and are not intended to restrict the present disclosure. An expression referencing a singular value additionally refers to a corresponding expression of the plural number, unless explicitly limited otherwise by the context. In the description, when it is said that one portion is described as “includes” any component, one element further may include other components unless no specific description is suggested.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, an embodiment of the present disclosure will be explained in detail with reference to the attached drawings. Before the present disclosure is disclosed and described, it is to be understood that the disclosed embodiments are merely exemplary of the disclosure, which can be embodied in various forms.

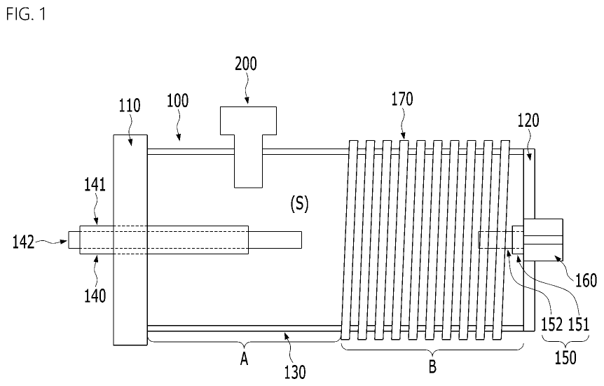

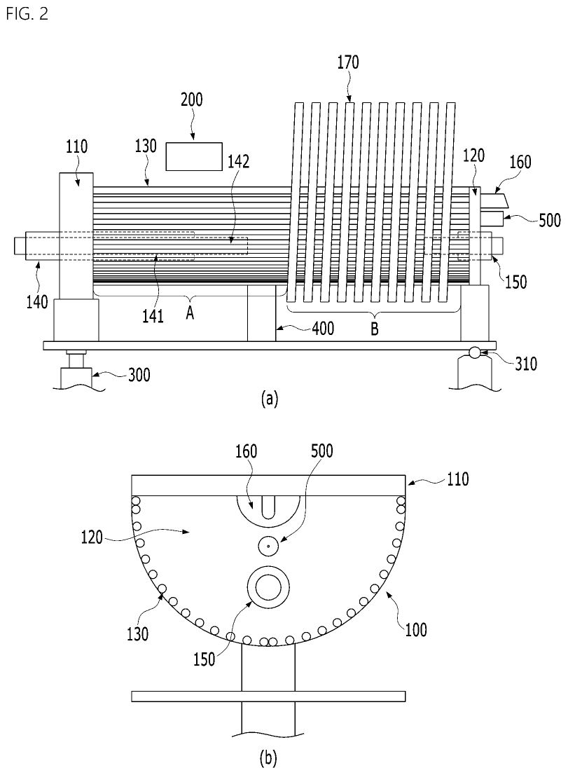

FIG. 1 and (a) of FIG. 2 are plan and side views showing a high refractive index metal oxide melting system according to the present disclosure.

The high refractive index metal oxide melting system according to the present disclosure largely includes a high frequency skull crucible 100 and a raw material feeder 200.

The high frequency skull crucible 100 includes a side wall 110 close to the raw material feeder 200, a side wall 120 formed on the opposite side to the side wall 110, and a body 130 located between the two side walls 110 and 120, and further, an outlet 160 is formed on a top end of the side wall 120 to discharge a melt therefrom.

The high frequency skull crucible 100 is provided with an internal space S defined by the body 130 located between the two side walls 110 and 120 to accommodate the melt therein. The high frequency skull crucible 100 has the shape of a semicylinder that is half of a cylinder or the shape of a cylinder whose given upper portion is cut.

The high frequency skull crucible 100 is largely divided into a first portion A on which the raw material feeder 200 is located and a second portion B where the outer peripheral surface of the body 130 is surrounded with high frequency coils 170.

A high refractive index metal oxide, which is put into the upper portion of the first portion A of the high frequency skull crucible 100 through the raw material feeder 200, is melted by means of high frequency induction heating induced by the high frequency coils 170 located on the second portion B, and the melted metal oxide is discharged through the outlet 160.

The body 130 of the high frequency skull crucible 100 according to the present disclosure includes a plurality of fingers 131, 132, 133, . . . .

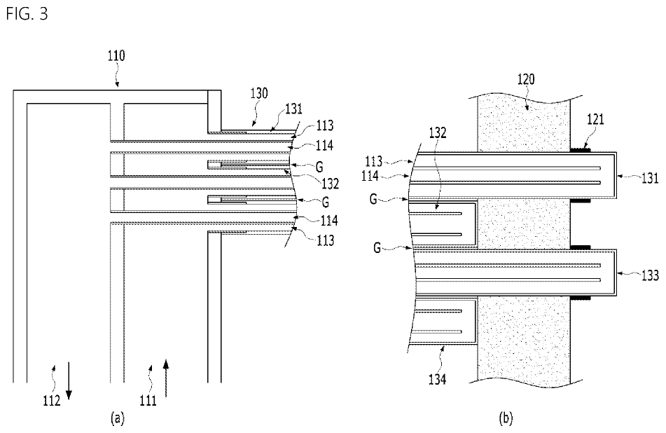

(a) of FIG. 3 and (b) of FIG. 3 show states where the plurality of fingers are connected to the side wall 110 and the side wall 120 of the high frequency skull crucible 100.

As shown in (a) of FIG. 3, the side wall 110 of the high frequency skull crucible 100 is in fluid communication with the plurality of fingers, and the side wall 110 and the plurality of fingers are made from a metal having high thermal conductivity, so that cooling water flows along the side wall 110 and the plurality of fingers to cause the melted metal oxide to be cold therein. While the metal oxide is being melted, accordingly, crust is formed on the side wall 110 and the plurality of fingers to prevent the melted metal oxide from leaking (Skull crucible structure).

Further, an inflow path 111 and an outflow path 112 into and from which the cooling water flows are formed inside the side wall 110 close to the raw material feeder 200, and the inflow path 111 communicates with inflow paths 113 of the fingers. That is, the cooling water supplied to the inflow path 111 of the side wall 110 passes through the inflow paths 113 and outflow paths 114 of the fingers sequentially and is discharged through the outflow path 112 of the side wall 110. Through the flow of the cooling water, the crust is formed on the high frequency skull crucible 100.

The side wall 110 close to the raw material feeder 200 is made from stainless steel, and the fingers 131, 132, 133, . . . are made from copper.

Since copper is a non-ferrous metal, a hysteresis loss does not occur, but an eddy current loss occurs. Electric current generated from the fingers causes power loss, and therefore, the fingers have to be configured and arranged to allow magnetic force lines to be minimizedly blocked by the high frequency coils 170. That is, one side of each finger has to be open, not closed.

(b) of FIG. 3 shows the state where the fingers 131, 132, 133, . . . are coupled to the side wall 120.

The side wall 120 on which the outlet 160 is formed is located close to the high frequency coils 170, and accordingly, the side wall 120 is exposed at a higher temperature than the side wall 110 close to the raw material feeder 200. Further, the side wall 120 has the outlet 160 for discharging the melt, and therefore, the side wall 120 has to be made from a material resistant to a temperature of the melt.

Accordingly, the side wall 120 is made from the same material as the melt, that is, a high refractive index metal oxide brick or fused cast refractory.

As shown in (b) of FIG. 3, the first finger 131 is fixed to the outer surface of the side wall 120 by means of a stopper 121, and the second finger 132 is located next to the first finger 131 in such a way as to allow the end thereof to be brought into contact with the inner surface of the side wall 120. Further, the third finger 133 and the fourth finger 134 are continuously located in the same manner as the first finger 131 and the second finger 132.

The side wall 120 is prevented from moving forward and backward by means of the first and third fingers 131 and 133 fixed to the outer surface thereof by means of the stoppers 121 and the second and fourth fingers 132 and 134 whose ends are brought into contact with the inner surface thereof, so that the side wall 120 is stably fixed, without any additional fixing device, and the fingers are kept open, not closed.

That is, the body 130 of the high frequency skull crucible 100 is formed of the fingers arranged horizontally between the side wall 110 and the side wall 120.

To allow the side wall 120 made from the high refractive index metal oxide brick or fused cast refractory to be stable structurally, without being melted by the melt, crust has to be formed. That is, cooling is required for the side wall 120.

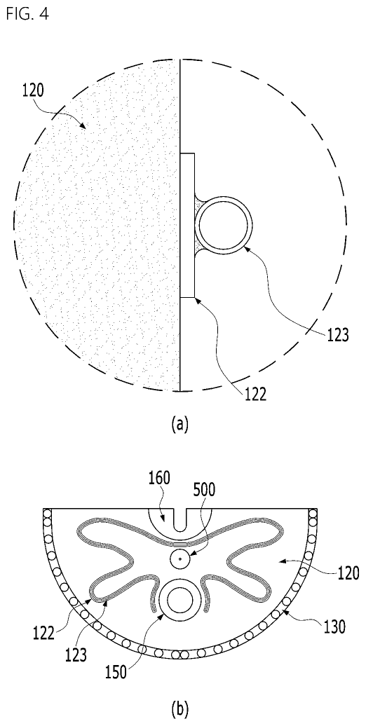

To cool the side wall 120, as shown in (a) of FIG. 4, a metal plate 122 having excellent thermal conductivity is attached to the outer surface of the high refractive index metal oxide brick or fused cast refractory, and further, a cooling pipe 123 is connected to the metal plate 122 by means of welding. The metal plate 122 and the cooling pipe 123 are made from copper, and because copper is a non-ferrous metal, a hysteresis loss does not occur. The arrangements of the metal plate 122 and the cooling pipe 123 are freely changed according to the type of the high refractive index metal oxide melted and the type of brick or fused cast refractory (See (b) of FIG. 4), but the metal plate 122 and the cooling pipe 123 are arranged to provide no closed circuit, so that a power loss caused by the generation of eddy current should not occur.

To enable the high frequency induction heating induced by the high frequency coils 170 to be performed, further, a given gap G has to be formed between the neighboring fingers to allow the magnetic force lines generated from the high frequency coils 170 to pass therethrough.

The given gap G between the fingers is set to allow the crust of the melt formed by the cooling of the fingers to be resistant to the weight of the melt.

However, in the case of the horizontally arranged high frequency skull crucible 100 having the shape of the semicylinder that is half of a cylinder or a cylinder whose given upper portion is cut according to the present disclosure, the load applied to the fingers is higher than that applied to fingers vertically arranged on a skull crucible, and therefore, it is hard to maintain the gap G between the fingers.

According to the present disclosure, to allow the gap G between the fingers to be kept, while a large amount of melt is being accommodated in each finger, an insulation member is located between the neighboring fingers, and a reinforced layer is formed on the outsides of the fingers.

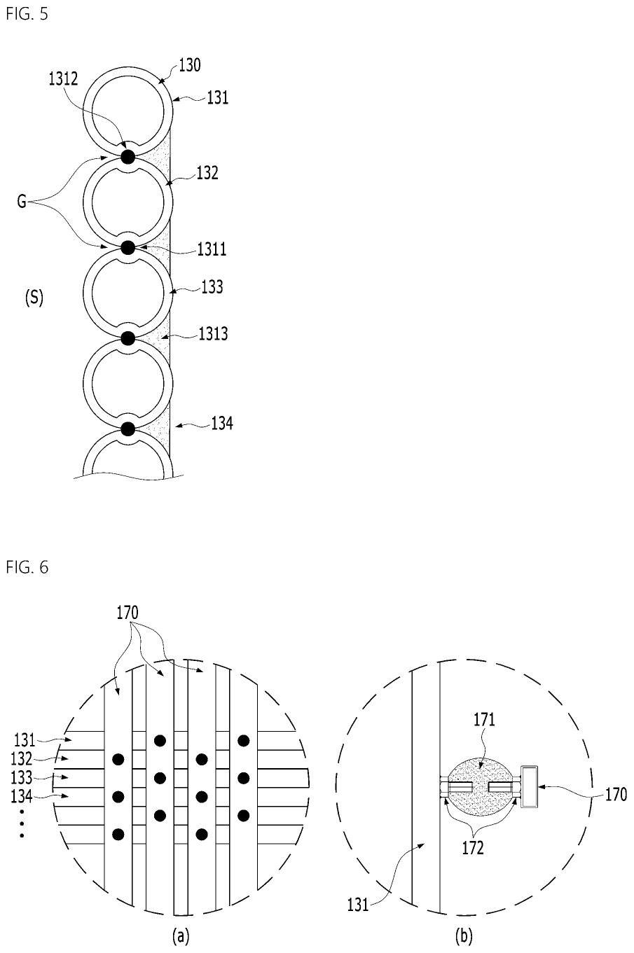

FIG. 5 shows the neighboring fingers constituting the body 130.

As shown in FIG. 5, each finger has the shape of a cylindrical pipe having grooves 1312 formed on both sides thereof in such a way as to locate insulation rods 1311 thereonto. That is, the grooves 1312 of the neighboring fingers are arranged adjacent to each other, and the insulation rods 1311 are located onto the grooves 1312, so that the gap G is formed between the neighboring fingers to pass the magnetic force line therethrough.

Accordingly, the high frequency skull crucible 100 is more resistant to high load than that where the cylindrical pipes are simply arranged side by side, while having the gaps G thereamong.

A Teflon rod may be used as the insulation rod.

Further, a reinforced layer 1313 is formed on the outsides of the fingers (that is, on the opposite side to the internal space of the high frequency skull crucible 100) to fixedly support the fingers, while having thermal insulating properties, so that the high frequency skull crucible 100 has a strong structure.

The reinforced layer 1313 is made from an epoxy resin having thermal insulating properties, heat resistance, and high strength.

As mentioned above, the fingers constituting the body 130 of the high frequency skull crucible 100 according to the present disclosure are arranged horizontally so that the high frequency skull crucible 100 has the shape of the semicylinder or the shape of the cylinder whose given upper portion is cut. Like this, the high frequency skull crucible 100 having the shape of the semicylinder or the shape of the cylinder whose given upper portion is cut according to the present disclosure is located inclinedly by a given angle from the ground, thereby advantageously making the melt consistently.

Further, the horizontally arranged fingers have the shapes of the cylindrical pipes having the grooves formed on both sides thereof, and the insulation rods such as Teflon rods are inserted into the grooves to form the gaps G between the neighboring fingers, so that the fingers are resistant to high load. Besides, the reinforced layer such as epoxy resin is added to the outsides of the fingers, thereby allowing the high frequency skull crucible 100 to have a strong structure.

Moreover, the fingers are alternately fixed to the outer and inner surfaces of the side wall 120 to improve the fixing forces to the side wall 120, thereby improving the structural stability of the high frequency skull crucible 100.

Hereinafter, an explanation of a high frequency skull crucible according to another embodiment of the present disclosure will be given.

As shown in FIG. 1 to (b) of FIG. 2, the high frequency skull crucible 100 according to another embodiment of the present disclosure has the high frequency coils 170 adapted to generate magnetic forces for high frequency induction heating. The high frequency coils 170 are fixed to the body 130, while surrounding the second portion B of the body 130 of the skull crucible 100.

As shown in (a) of FIG. 6 and (b) of FIG. 6, the high frequency coils 170 are fixed to the fingers 131, 132, . . . by means of multi-point connection, and insulators 171 are fixedly arranged between fixing members 172 welded to the high frequency coils 170 and the fingers, are fixed to the fixing members 172, while being spaced apart from one another.

As the high frequency coils 170 and the fingers are coupled to one another by means of the multi-point connection, while being kept to insulated states from one another, the structural stability of the high frequency skull crucible 100 is greatly improved.

Hereinafter, an explanation of the high frequency skull crucible 100 according to yet another embodiment of the present disclosure will be given.

As shown in FIG. 1 to (b) of FIG. 2, the high frequency skull crucible 100 according to yet another embodiment of the present disclosure has a first electrode rod 140 passing through the side wall 110 close to the raw material feeder 200 and a second electrode rod 150 located to face the first electrode rod 140, while passing through the side wall 120 on which the outlet 160 is formed.

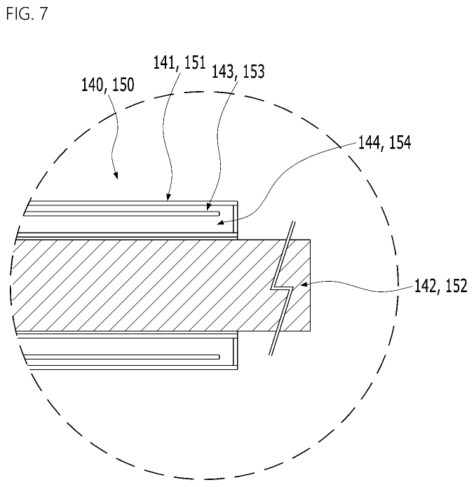

As shown in FIG. 7, the first and second electrode rods 140 and 150 include electrodes 142 and 152 and cooling pipes 141 and 151 adapted to surround the electrodes 142 and 152 and having cooling water inflow paths 143 and 153 and cooling water outflow paths 144 and 154 for cooling the electrodes 142 and 152.

If the raw material fed through the raw material feeder 200 is melted by means of the high frequency induction heating, resistivity and permeability values of the raw material become varied by means of temperature rising, thereby causing high frequency absorptivity to be varied. Accordingly, even though the power of the high frequency coils 170 increases at a given temperature or more, the absorptivity of the raw material decreases, so that a temperature of the melt becomes low, which makes it impossible to perform the high frequency induction heating anymore.

To solve such problems, accordingly, the first and second electrode rods 140 and 150 serve to directly apply currents to the melt so that a melting temperature is kept.

Desirably, molybdenum electrodes, which are stably kept even on a melting point of the high refractive index metal oxide, are used as the first and second electrode rods 140 and 150, and desirably, direct current power is applied to the first and second electrode rods 140 and 150 to allow the entire high frequency skull crucible 100 to be grounded.

Accordingly, the high frequency skull crucible 100 according to the present disclosure stably maintains the melting temperature of the high refractive index metal oxide whose resistivity and permeability values are varied at a temperature higher than the melting point thereof.

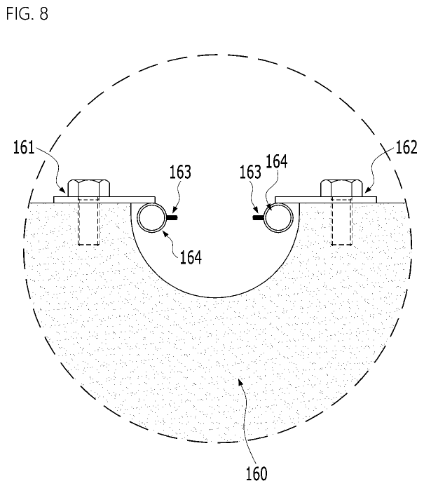

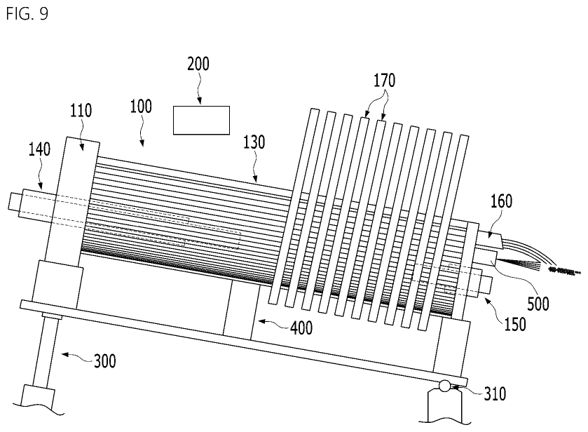

As shown in FIG. 8, the high frequency skull crucible 100 according to the present disclosure includes third and fourth electrode rods 161 and 162 located on the outlet 160.

The third and fourth electrode rods 161 and 162 apply currents to the high temperature melt flowing through the outlet 160 to prevent the melt from being solidified in the outlet 160 and thus clogging the outlet 160.

The third and fourth electrode rods 161 and 162 include electrodes 163 and cooling pipes 164 for cooling the electrodes 163, and the electrodes 163 are desirably made from a rhodium-platinum alloy to prevent the occurrence of abrasion caused by contact and friction with the melt having high viscosity. In detail, the electrodes 163 are made from platinum in which 20% of rhodium is contained. The cooling pipes 164 are made from stainless steel.

When the high temperature melt is discharged through the outlet 160, the high frequency skull crucible 100 according to the present disclosure prevents the melt from being cool in the outlet 160 and thus clogging the outlet 160, thereby advantageously making the metal oxide melt consistently.

As shown in FIG. 1 to (b) of FIG. 2, the high refractive index metal oxide melting system according to the present disclosure further includes an ascending and descending part 300 for ascending and descending the side wall 110 close to the raw material feeder 200 of the high frequency skull crucible 100 and a hinge shaft 310 located on the side wall 120 on which the outlet 160 is formed. The ascending and descending part 300 serves to allow the high frequency skull crucible 100 to be inclined to discharge the melt through the outlet 160.

The ascending and descending part 300 serves to adjust the high frequency skull crucible 100 in such a way as to allow the high frequency skull crucible 100 to be inclined to a given angle with respect to the ground, so that the time during which the raw material stays in the high frequency skull crucible 100 is adjustable.

So as to initially put the raw material into the high frequency skull crucible 100, in detail, the ascending and descending part 300 moves down to allow the high frequency skull crucible 100 to be parallel to the ground, and next, the raw material is fed to the high frequency skull crucible 100 through the raw material feeder 200. After the completion of the raw material feeding, power is applied to the high frequency coils 170 to allow the raw material to be uniformly melted through the high frequency induction heating, and next, the ascending and descending part 300 moves up to allow the melt to be discharged through the outlet 160.

After the melt has been discharged, the ascending and descending part 300 moves down again to allow the raw material to be fed by the amount of melt discharged into the high frequency skull crucible 100, and next, the raw material is melted and discharged.

The ascending and descending part 300 moves up to allow the melt to be first discharged, and in the state where the ascending and descending part 300 is kept moving up (that is, in the state where the high frequency skull crucible 100 is inclined), if the amount of raw material corresponding to the amount of melt discharged is additionally fed, the melt is made consistently.

Accordingly, the high temperature metal oxide melt can be made consistently.

As shown in (a) of FIG. 2 and (b) of FIG. 2, the high refractive index metal oxide melting system according to the present disclosure further includes an air nozzle 500 located under the outlet 160 or on one side of the outlet 160 to inject air into the melt discharged through the outlet 160. The air nozzle serves to scatter the melt and thus to make metal oxide beads, and in this case, the air nozzle 500 is formed integrally with or separately from the high frequency skull crucible 100.

Therefore, the high frequency skull crucible 100 according to the present disclosure serves to directly melt the metal oxide, while simultaneously making the metal oxide beads.

FIG. 9 shows an example where the metal oxide beads are made using the high refractive index metal oxide melting system according to the present disclosure. In FIG. 9, the high frequency skull crucible 100 is located inclinedly by means of the ascending and descending part 300, but of course, the high frequency skull crucible 100 may be fixed to an inclined floor in such a way as to keep a given inclination angle.

As described above, the high frequency skull crucible according to the present disclosure is provided with the body having the shape of the semicylinder or the shape of the cylinder whose given upper portion is cut in such a way as to be located horizontally from the ground, and accordingly, the high frequency skull crucible is located inclinedly by a given angle from the ground, thereby making it possible to make the melt consistently.

In addition, the high frequency skull crucible according to the present disclosure is provided with the body that is formed of the cylindrical fingers having the grooves formed thereon to locate the insulation rods thereon and the reinforced layer that is formed on the outsides of the fingers, so that the fingers are resistant to high load, thereby allowing the high frequency skull crucible to be strong structurally.

Further, the fingers are alternately fixed to the outer and inner surfaces of the side wall on which the outlet is formed, so that the side wall on which the outlet is formed is stably fixed, without any additional fixing device, and the fingers are kept open, not closed.

Moreover, the high frequency skull crucible according to the present disclosure is provided with the pair of electrode rods facing each other in such a way as to pass through the two side walls, thereby stably keeping the melting temperature of the high refractive index metal oxide whose resistivity and permeability values are varied at a temperature higher than the melting point thereof.

Furthermore, the high frequency skull crucible according to the present disclosure is provided with the pair of electrode rods located on the outlet to heat the melt discharged from the outlet, so that when the high temperature melt is discharged through the outlet, the pair of electrode rods prevents the melt from being cool in the outlet and thus clogging the outlet, thereby allowing the metal oxide melt to be made consistently.

Additionally, the high frequency skull crucible according to the present disclosure is configured to allow the high frequency coils and the fingers to be fixed to one another by means of the multi-point connection, thereby being more improved in structural stability.

Further, the high refractive index metal oxide melting system according to the present disclosure is provided with the high frequency skull crucible, the raw material feeder located above the high frequency skull crucible to feed the raw material to the interior of the high frequency skull crucible, and the ascending and descending part for moving up and down the side wall close to the raw material feeder of the high frequency skull crucible, thereby making it possible to make the high refractive index metal oxide melt consistently.

Besides, the high refractive index metal oxide melting system according to the present disclosure is provided with the air nozzle for injecting air into the melt discharged through the outlet, thereby making high refractive index metal oxide beads.

While the present disclosure has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A high frequency skull crucible comprising:
a side wall close to a raw material feeder and a side wall on which an outlet is formed, the two side walls being located vertically to face each other;
a body located between the two side walls; and
high frequency coils adapted to surround a portion of the body that is close to the side wall on which the outlet is formed,
wherein the side wall on which the outlet is formed has the outlet formed on top thereof to discharge a melt, the body has the shape of a horizontally located semicylinder or the shape of a horizontally located cylinder whose given upper portion is cut, and the body is inclinedly located on the ground to allow the melt to be made consistently.

2. The high frequency skull crucible according to claim 1, wherein the body comprises a plurality of cylindrical fingers having grooves formed thereon to insert insulation rods thereinto, so that gaps are formed among the neighboring fingers in such a way as to pass magnetic force lines generated from the high frequency coils therethrough.

3. The high frequency skull crucible according to claim 2, wherein the insulation rods are made from Teflon.

4. The high frequency skull crucible according to claim 2, wherein the body further comprises a reinforced layer formed on the outsides of the fingers.

5. The high frequency skull crucible according to claim 4, wherein the reinforced layer is made from an epoxy resin.

6. The high frequency skull crucible according to claim 2, wherein the side wall close to the raw material feeder is in fluid communication with the plurality of fingers.

7. The high frequency skull crucible according to claim 2, wherein some of the plurality of fingers are fixed to the outer surface of the side wall on which the outlet is formed, and some of the plurality of fingers are located in such a way as to allow the ends thereof to be brought into contact with the inner surface of the side wall on which the outlet is formed.

8. The high frequency skull crucible according to claim 7, wherein the plurality of fingers fixed to the outer surface of the side wall on which the outlet is formed are alternately arranged with the plurality of fingers located in such a way as to allow the ends thereof to be brought into contact with the inner surface of the side wall on which the outlet is formed.

9. The high frequency skull crucible according to claim 6, wherein the side wall close to the raw material feeder is made from stainless steel, the plurality of fingers are made from copper, and the side wall on which the outlet is formed is made from a high refractive index metal oxide brick or fused cast refractory.

10. The high frequency skull crucible according to claim 9, further comprising a cooling structure located on the outer surface of the side wall on which the outlet is formed to cool the side wall on which the outlet is formed.

11. The high frequency skull crucible according to claim 10, wherein the cooling structure comprises a metal plate fixed to the side wall on which the outlet is formed and a cooling pipe welded to the metal plate.

12. The high frequency skull crucible according to claim 1, further comprising a pair of electrode rods passing through the side wall close to the raw material feeder and the side wall on which the outlet is formed in such a way as to be located to face each other.

13. The high frequency skull crucible according to claim 12, wherein each electrode rod comprises an electrode and a cooling pipe for surrounding the electrode in such a way as to allow cooling water to flow therein and therefrom.

14. The high frequency skull crucible according to claim 13, wherein the electrode is made from molybdenum.

15. The high frequency skull crucible according to claim 1, wherein the outlet has a pair of electrode rods formed thereon to heat the melt discharged therefrom.

16. The high frequency skull crucible according to claim 15, wherein each electrode rod comprises an electrode and a cooling pipe for cooling the electrode, and the electrode is made from a rhodium-platinum alloy.

17. The high frequency skull crucible according to claim 2, wherein the plurality of fingers and the high frequency coils are fixed to one another by means of multi-point connection.

18. The high frequency skull crucible according to claim 17, wherein the multi-point connection is performed through fixing members fixedly welded to the high frequency coils, fixing members fixedly welded to the plurality of fingers, and insulators arranged between the fixing members.

19. A high refractive index metal oxide melting system comprising:
the high frequency skull crucible according to claim 1;
the raw material feeder located above the high frequency skull crucible to feed a raw material to the interior of the high frequency skull crucible; and
an ascending and descending part for moving up and down the side wall close to the raw material feeder of the high frequency skull crucible.

20. The high refractive index metal oxide melting system according to claim 19, further comprising an air nozzle located on one surface or one side of the side wall on which the outlet is formed to inject air into the melt discharged through the outlet.
